(19) United States
(12) Patent Application Publication
(10) Pub. No.: US 2026/0014874 A1
(43) Pub. Date: Jan. 15, 2026

(54) BATTERY SAFETY DEVICE FOR ENSURING COMPLIANCE WITH FUNCTIONAL SAFETY REQUIREMENTS

(71) Applicant: SENSATA TECHNOLOGIES, INC., ATTLEBORO, MA (US)

(72) Inventor: OLE TIDEMANN, LYNGE (DK)

(21) Appl. No.: 18/770,326

(22) Filed: Jul. 11, 2024

(51) Int. Cl. B60L 3/00; B60L 3/04; H01M 10/42; H01M 10/48

(52) U.S. Cl. CPC B60L 3/0046; B60L 3/04; H01M 10/425; H01M 10/482; H01M 10/486; H01M 2010/4271; H01M 2220/20

(57) ABSTRACT

In an embodiment, an apparatus includes a battery having one or more battery cells. The apparatus also includes a battery safety device coupled to the battery, where the battery safety device is configured to receive one or more analog signals indicating a measured value of an operational characteristic of a battery cell, and change a state of a control signal in response to detecting that the measured value of the operational characteristic is outside of a safe operating area that is defined for the battery. The apparatus also includes a contactor configured to disconnect the battery from a load based on the control signal. The operational characteristic can include voltage, temperature, and/or current in the battery. The battery safety device is remote from the BMS.

### BACKGROUND

Electric vehicles and other electric-powered device typically include a battery management system. The battery management system manages the state of charge and state of health of the battery. Often, the battery management system is also tasked with safety monitoring. The voltage, current, and/or temperature of the battery is monitored to ensure that the battery is operating in the safe operating area. However, the chemistry of a battery can vary and functional safety standards can change.

### SUMMARY

Embodiments in accordance with the present disclosure are directed to a battery safety device that separates functional safety functions from a battery management system (BMS). As such, compliance with functional safety standards can be achieved for existing battery management systems that are currently not compliant with any functional safety standard. Further, embodiments do not require safety certified battery monitoring devices that are used as a part of a conventional BMS. Still further, battery monitoring devices that are used by an associated BMS can be replaced with less expensive or simpler monitoring devices that are not safety certified. With the embodiments herein, functional safety standard compliance becomes an add-on to a BMS, allowing field upgrade with certified functional safety features and reducing the time to market for developing BMS's that do not include functional safety compliant features.

In one embodiment, an apparatus includes a battery having one or more battery cells. The apparatus also includes a battery safety device coupled to the battery, where the battery safety device is configured to receive one or more analog signals indicating a measured value of an operational characteristic of a battery cell. The battery safety device is also configured to change a state of a control signal in response to detecting that the measured value of the operational characteristic is outside of a safe operating area that is defined for the battery. The apparatus also includes a contactor configured to disconnect the battery from a load based on the control signal. The operational characteristic can include voltage, temperature, and/or current in the battery. The battery safety device is remote from the BMS.

### BRIEF DESCRIPTION OF THE DRAWINGS

FIG. 1 sets forth a block diagram of an example system including a battery safety device for ensuring compliance with functional safety requirements in accordance with at least one embodiment of the present disclosure.

FIG. 2 sets forth a block diagram of another example system including a battery safety device for ensuring compliance with functional safety requirements in accordance with at least one embodiment of the present disclosure.

FIG. 3 sets forth a block diagram of another example system including a battery safety device for ensuring compliance with functional safety requirements in accordance with at least one embodiment of the present disclosure.

FIG. 4 sets forth a block diagram of another example system including a battery safety device for ensuring compliance with functional safety requirements in accordance with at least one embodiment of the present disclosure.

FIG. 5 sets forth a block diagram of another example system including a battery safety device for ensuring compliance with functional safety requirements in accordance with at least one embodiment of the present disclosure.

FIG. 6 sets forth a block diagram of another example system including a battery safety device for ensuring compliance with functional safety requirements in accordance with at least one embodiment of the present disclosure.

FIG. 7 sets forth a block diagram of another example system including a battery safety device for ensuring compliance with functional safety requirements in accordance with at least one embodiment of the present disclosure.

FIG. 8 is a flowchart of an example method of a battery safety device for ensuring compliance with functional safety requirements in accordance with at least one embodiment of the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

Lithium-Ion batteries must be protected against operation outside of their safe operating area (SOA), defined by limits for undervoltage and overvoltage, under-temperature and overtemperature, and overcurrent. Traditionally, the most important role of a battery management system (BMS) is to implement functional safety functions in accordance with safety goals to ensure that the managed battery is not operated outside its SOA. Another important function of a BMS is to provide information regarding the status of the battery in terms of state-of-charge, state-of-health, and other battery cell information. While the latter functions are important, these are typically not considered safety critical. Nevertheless, conventional BMSs typically combine the implementation of the functional safety requirements with the non-functional safety requirements. To perform the functional safety functions as well as the non-functional safety functions, information about battery cell voltages and cell temperatures is typically fetched by dedicated battery monitoring devices, (e.g., analog front ends (AFEs)), and communicated to a central microcontroller.

A BMS that is compliant with such safety standards is inherently more expensive and complex than a BMS that is not compliant with any safety standard. Further, dedicated battery monitoring devices such as AFEs that are compliant with functional safety standards are inherently expensive. Moreover, the configuration of the SOA-protection limits often requires dedicated tools, is time-consuming, and is prone to errors. Some BMSs may not be able to support such function safety features.

A battery safety device in accordance with the present disclosure deliberately breaks with the principle of combining functional safety features with battery state management in a BMS, thus minimizing functional safety standard related design measures and reducing the cost needed to obtain functional safety. The battery safety device of the present disclosure eliminates the need for designing a traditional BMS compliant with any functional safety standard and yet still being able to provide compliance with relevant functional safety standards. Further, the battery safety device can be used to obtain certified functional safety compliance with functional safety standards even though the BMS in use is not compliant with such standards. In some examples, battery SOA assessment and related action (e.g., transition to safe state) is performed right at the battery, separately from the BMS, thus eliminating the need for communication and processing of safety related information requiring proven safe handling.

In accordance with at least one embodiment, a battery safety device receives analog measurement data for one or more cells of a battery. When the measurement data indicates that the battery is operating outside of its safety requirements, the battery safety device interrupts the supply of current to a load on the battery. The battery safety device is separate from a BMS and operates without control by a BMS. In some examples, the battery safety device is a component of the battery itself or the battery pack containing the battery. The battery safety device ensures that the battery does not operate outside of its SOA and therefore complies with functional safety requirements. As such, compliance with such safety requirements is removed from the BMS. The BMS retains its function for calculating the battery state-of-charge and other battery characterization functions. However, the safety and protection functions typically included in a BMS are no longer needed.

In at least one implementation, the battery safety device includes a microcontroller and an analog-to-digital converter (ADC). The ADC receives measurement data from the battery, such as voltage, current, and/or temperature within the battery or individual battery cells. The ADC converts the measurement data into digital signals that are provided to the microcontroller. When the microcontroller determines that the measurement data indicates that the battery is operating outside of safety requirements, the microcontroller signals a circuit break to a battery contactor. In response to the circuit break signal, the battery contactor disconnects the battery from a power distribution system and the battery is transitioned to a safe state. In some variations, the microcontroller may be an application specific integrated circuit, while in other variations the microcontroller may be a general purpose processor that executers computer-readable instructions stored, for example, as firmware or a memory device.

In another implementation, the battery safety device ensures safety compliance using analog components, thus eliminating the need for an ADC, microcontroller, or software. In the case of an SOA violation detected by the analog components, the battery safety device signals a circuit break to a battery contactor. In response to the circuit break signal, the battery contactor disconnects the battery from a power distribution system and the battery is transitioned to a safe state. In these examples, the protection principle for undervoltage and overvoltage is based on an analog comparison between the individual cell voltages and two reference voltages established by resistive voltage dividers. As such, the battery safety device includes analog comparators for making these comparisons. The battery safety device uses the voltage dividers to provide an under/over voltage reference matching the SOA-voltage limits for the specific battery type. It will be appreciated that the SOA-cell voltage limits of a particular battery are not chemistry agnostic. The same protection principle applies for under-temperature and over-temperature detection and protection using temperature comparators.

In some examples, the current is measured by the voltage drop over a shunt resistor or by means of a Hall sensor. As overcurrent limits are temperature dependent, it is assumed that the overall ambient battery temperature is kept within defined limits to support one single overcurrent limit only. This temperature may be controlled by an external device and is not within the scope of this disclosure. However, if the ambient battery temperature gets below or above these limits, the battery safety device will still enter safe state based on signals from the comparators for under-temperature and overtemperature.

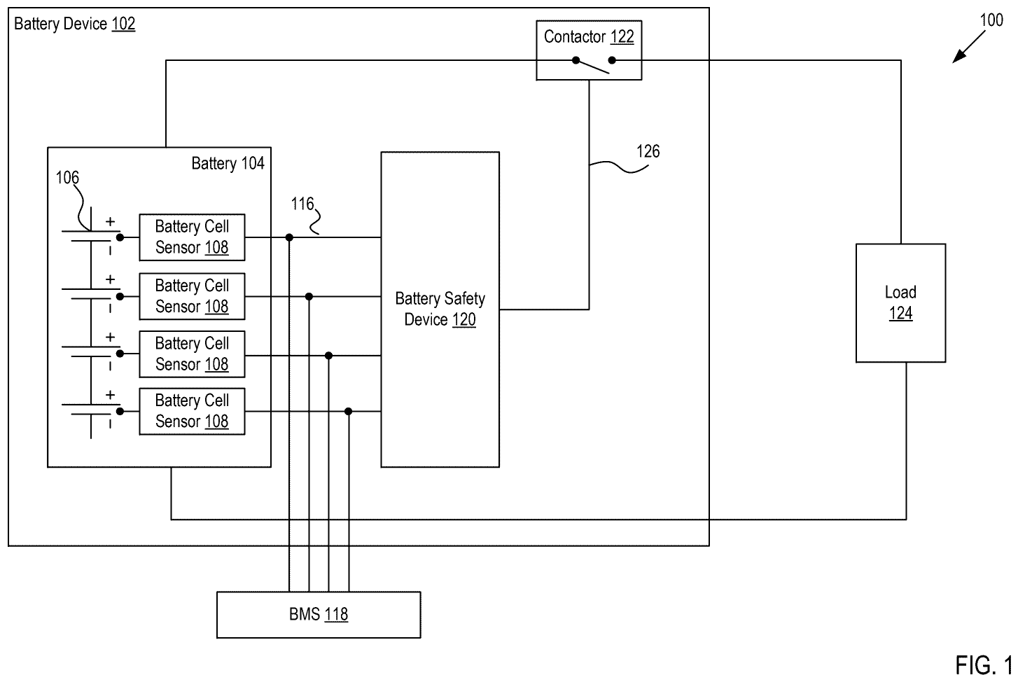

For further explanation, FIG. 1 sets forth a block diagram of an example system 100 including a battery safety device for ensuring compliance with functional safety requirements in accordance with at least one embodiment of the present disclosure. The system 100 includes a battery 104 having one or more battery cells 106. The battery 104 also includes one or more battery cell sensors 108. Each battery cell 106 may be coupled to a respective battery cell sensor 108, as shown, although other sensor arrangements are contemplated. A battery cell sensor 108 is configured to measure the voltage, current, and/or temperature of a battery cell 106. In some examples, the battery cell sensors 108 provide voltage monitoring using a voltage sensor (not shown) to ensure each cell is operating within its specified voltage range by measuring the voltage across the terminals of each battery cell 106. For example, the voltage sensor may be a voltage probe that measures a voltage in the battery cell 106. In some examples, the battery cell sensors 108 provide temperature monitoring to prevent overheating, which can lead to thermal runaway, and to ensure optimal charging and discharging conditions. For example, the battery cell sensor 108 can include a temperature sensor (not shown), such as thermistors or resistance temperature detector, that is placed near the battery cells 106 to measure their temperature. In some examples, the battery cell sensors 108 provide current monitoring to track the current flowing in and out of each battery cell 106, ensuring safe charging and discharging cycles, through the use of a current sensor (not shown) such as a shunt resistor or Hall effect sensor to measure the current. In some examples, these measurements are output by each battery cell sensor 108 as one or more analog signals 116. Although only one analog signal 116 is shown for clarity, it will be appreciated that multiple analog signals may be output by the battery 104. For example, the battery 104 may output a set of analog signals 116 including analog signals output by each battery cell sensor 108. However, it is contemplated that one or more multiplexors can be utilized such that the one or more analog signals 116 output by the battery 104 correspond to one battery cell sensor 108 at a time, as will be expanded upon below.

The system 100 also includes a battery management system (BMS) 118 coupled to the battery 104. The BMS 118 performs functions related to state of charge (SOC) estimation by determining the remaining charge in each cell, ensuring balanced charging and usage. Thus, the BMS 118 may identify voltage, current, and temperature data based on the one or more analog signals 116 to estimate the SOC. The BMS 118 also performs state of health (SOH) assessment to evaluate the long-term health and capacity of each cell by, for example, analyzing voltage, temperature, and historical performance data to estimate how much the battery capacity has degraded over time. In a particular implementation, the BMS 118 either provides no functional safety protection or provides protection that does not ensure compliance with the SOA requirements of the battery 104.

The system 100 also includes a battery safety device 120 in accordance with the present disclosure. The battery safety device 120 is remote from the BMS 118 and thus is configured to operate independent of the BMS 118. The battery safety device 120 is configured to detect when the battery 104 or any one battery cell 106 is operating outside of limits defined by the SOA. The limits used by the battery safety device 120 and defined by the SOA can be provided by hardware or software/firmware, as expanded upon below. Compliance with the SOA ensures that the battery 104 operates within a range that meets functional safety requirements. Thus, compliance with functional safety requirements is ensured by the battery safety device 120 and not the BMS 118, thereby simplifying BMS design and allowing the definition of battery-specific limits.

In some examples, the battery safety device 120 is configured to detect when the battery 104 or any one battery cell 106 is operating outside of limits for undervoltage and overvoltage. Thus, the battery safety device 120 is configured to detect when a battery cell 106 is providing too little or too much voltage and, if so, place the battery in a safe state. In some examples, the battery safety device 120 is configured to detect when the battery 104 or any one battery cell 106 is operating outside of limits for under-temperature and over-temperature. Thus, the battery safety device 120 is configured to detect when the conditions of a battery cell 106 are too hot or too cold and, if so, place the battery in a safe state. In some examples, the battery safety device 120 is configured to detect when the battery 104 or any one battery cell 106 is operating outside of current limits (e.g., overcurrent). Thus, the battery safety device 120 is configured to detect when a battery cell 106 is supplying too much current and, if so, place the battery in a safe state. In some examples, the battery safety device 120 is configured to detect when the battery 104 or any one battery cell 106 is operating outside of limits for any combination of undervoltage and overvoltage, under-temperature and overtemperature, and overcurrent.

In some examples, the battery safety device 120 is configured to place the battery 104 in a safe state by operating a contactor 122. The contactor 122 is configured to break an electrical circuit formed by the positive and negative terminals of the battery 104 and a load 124. For example, the load 124 may be an electric power distribution system of an electric vehicle. In a particular example, the contactor 122 is a battery contactor within a battery pack (not shown), where the battery contactor is configured to open and close a circuit between the battery 104 and a power distribution unit (PDU) (not shown). In some examples, when the battery safety device 120 detects that the battery is operating outside of the SOA, a contactor control signal 126 is triggered, for example, by asserting the contactor control signal 126 high. In response to detecting that the contactor control signal 126 is triggered, the contactor 122 opens a switch that disconnects the supply of electric power to the load 124.

The system 100 may be realized by a variety of arrangements. In one example, battery 104, battery safety device 120, and contactor 122 are enclosed within a battery device 102, such as a battery pack, while the BMS 118 is remote from the battery pack. In yet another example, the battery safety device 120 is coupled to a battery pack that encloses the battery 104. In some examples, the battery safety device 120 includes the contactor 122. Additional arrangements not specifically addressed here are also contemplated. However, the battery safety device 120 remains apart from the BMS 118 to facilitate the principles of the present disclosure.

In some examples, the system 100 is implemented in an electric vehicle. For example, the load 124 may be applied by a PDU that is connected to an inverter of the electric vehicle. The inverter powers the electric vehicle's motor. The battery safety device ensures that operation of the battery within the electric vehicle complies with functional safety requirements.

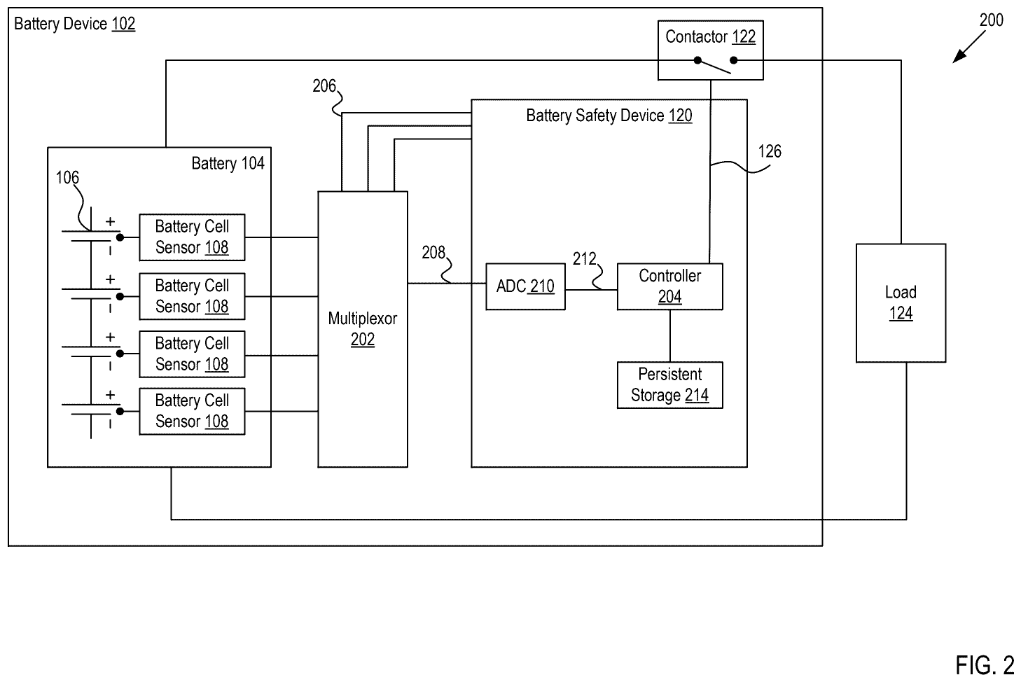

For further explanation, FIG. 2 sets forth a block diagram of an example system 200 including a battery safety device for ensuring compliance with functional safety requirements in accordance with at least one embodiment of the present disclosure, where the system 200 is one variation of the example system 100 of FIG. 1 where like numerals indicate like elements. In some examples, the system 200 includes one or more multiplexors 202 coupled to the battery 104 and configured to receive analog signals from each battery cell sensor 108. The one or more multiplexors 202 are addressable by a controller 204 of the battery safety device 120 via address signals 206. Using the address signals 206, the controller 204 controls multiplexor 202 to select one battery cell 106 at a time for outputting measurements to the battery safety device 120 via one or more analog signals 208. Although only one multiplexor 202 is shown, it will be appreciated that any multiplexor can be a point of failure, and as such the use of redundance multiplexors reduces the likelihood of failure of the battery safety device 120. Accordingly, in some examples, the system 200 includes two or more multiplexors 202.

In some examples, the battery safety device includes at least one analog-to-digital converter (ADC) 210 configured to receive the one or more analog signals 208 from the multiplexor 202, where the analog signals 208 indicate measurements of a particular battery cell sensor 108. The ADC 210 converts the analog signals 208 into digital signals 212 that are provided to the controller 204.

In some examples, the controller 204 is configured to detect when a battery cell 106 is providing too little or too much voltage and, if so, place the battery in a safe state. In some examples, the controller 204 is configured to detect when the battery 104 or any one battery cell 106 is operating outside of limits for under-temperature and overtemperature. Thus, the controller 204 is configured to detect when the conditions of a battery cell 106 are too hot or too cold and, if so, place the battery in a safe state. In some examples, the controller 204 is configured to detect when the battery 104 or any one battery cell 106 is operating outside of limits for overcurrent. Thus, the controller 204 is configured to detect when a battery cell 106 is supplying too much current and, if so, place the battery in a safe state. In some examples, the controller 204 is configured to detect when the battery 104 or any one battery cell 106 is operating outside of limits for any combination of undervoltage and overvoltage, under-temperature and overtemperature, and overcurrent. The controller performs these detections by comparing the values of data in the digital signals to reference values.

In some examples, the controller 204 is programmed with the voltage, temperature, and/or current limits for the SOA definition. When the controller 204 detects that the battery 104 is operating outside of the SOA limits, the controller triggers the contactor control signal 126, for example, by asserting the contactor signal 126 high. In response to detecting that the contactor control signal 126 is triggered, the contactor 122 opens the switch that disconnects the supply of electric power to the load 124.

In various examples, the controller 204 includes or implements a microcontroller, an Application Specific Integrated Circuit (ASIC), a general purpose processor, a digital signal processor (DSP), a programmable logic array (PLA) such as a field programmable gate array (FPGA), or other data computation unit in accordance with the present disclosure. In some examples, microcontroller is embedded with digital logic that carries out the SOA detection described above and in the accompanying figures. In some examples, the microcontroller executes computer program instructions that are stored in a persistent storage device 214. When executed by the controller 204, the computer program instructions cause the controller 204 to carry out the SOA detection described above and in the accompanying figures. The persistent storage device 214 device can be, for example, a flash memory device, firmware, and the like. In some examples, the persistent storage device 214 also stores the reference values voltage, temperature, and/or current limits of the SOA definition.

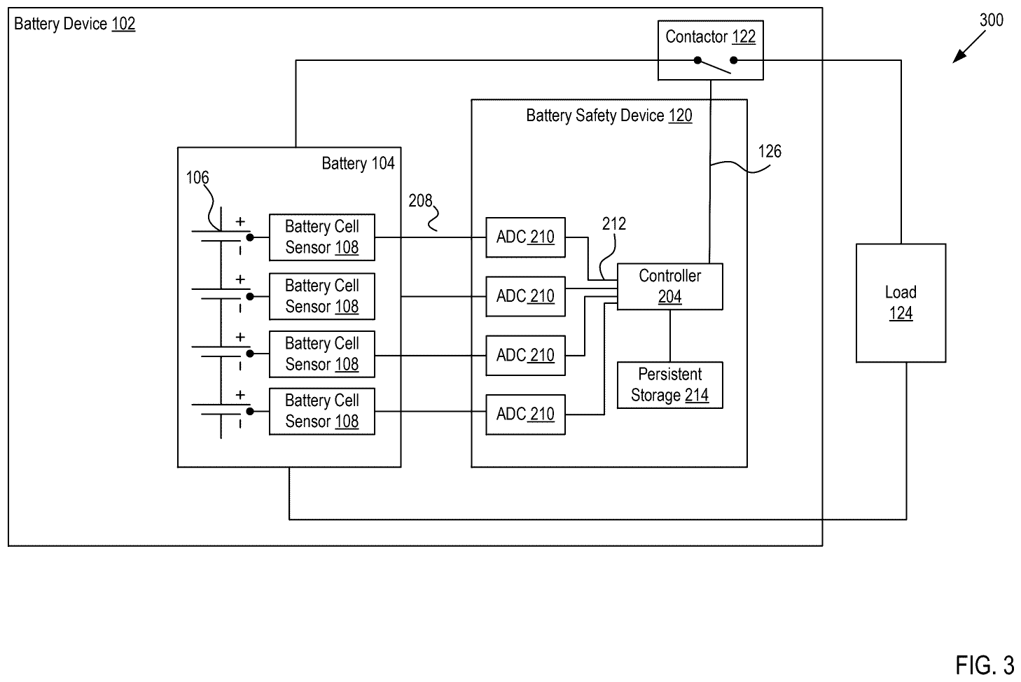

For further explanation, FIG. 3 sets forth a block diagram of an example system 300 including a battery safety device for ensuring compliance with functional safety requirements in accordance with at least one embodiment of the present disclosure, where the system 300 is one variation of the example system 200 of FIG. 2. In the example system 300 of FIG. 3, the one or more multiplexors 202 is replaced with multiple ADC's, including one ADC 210 for each battery cell sensor 108. In this way, the multiplexor addressing can be omitted, which may in some cases simply the system design.

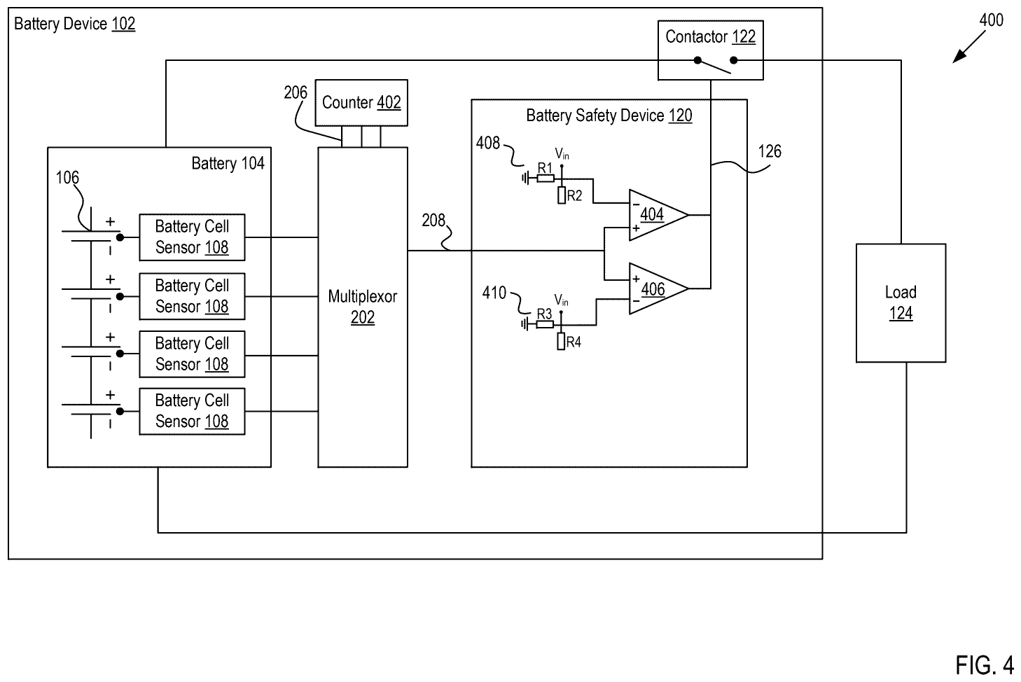

For further explanation, FIG. 4 sets forth a block diagram of an example system 400 including a battery safety device for ensuring compliance with functional safety requirements in accordance with at least one embodiment of the present disclosure, where the system 400 is one variation of the example system 100 of FIG. 1 where like numerals indicate like elements. In some examples, the system 400 includes one or more multiplexors 202, as described above, that are coupled to the battery 104 and configured to receive analog signals from each battery cell sensor 108. The system 400 also includes a binary counter 402. To simplify the design, the example battery safety device 120 of FIG. 4 does not include a microcontroller. The one or more multiplexors 202 are addressable by the binary counter 402 of the battery safety device 120 via address signals 206. Using the address signals 206, the binary counter 402 controls multiplexor 202 to select one battery cell 106 at a time for outputting measurements to the battery safety device 120 via one or more analog signals 208.

In the example of FIG. 4, the battery safety device includes two or more analog comparators 404, 406. The analog comparators 404, 406 compare two voltage levels and outputs a signal indicating which voltage is higher. The analog comparators 404, 406 each include an inverting input (−) that receives one of the voltages to be compared and a non-inverting input (+) that receives the other voltage to be compared. The analog comparators 404, 406 each include an output terminal that provides a signal based on the comparison of the input voltages. In the example of FIG. 4, one input is a reference voltage and the other input is an analog signal of the one or more analog signals 208. The comparator continuously compares the voltage at the non-inverting input (+) with the voltage at the inverting input (−). In a particular example, when V₊>V₋, the output is low (close to ground). When V₊<V₋, the output is high (close to the supply voltage of the comparator). However, it will be appreciated that whether the output signal is high or low based on the comparison may be implementation dependent. The reference voltage may be supplied, for example, using a voltage divider coupled to a supply voltage.

In the example of FIG. 4, a first analog comparator 404 is a low limit comparator. For example, the first analog comparator 404 is configured to detect undervoltage in a battery cell. In such an example, a first voltage divider 408 is coupled to the inverting input (−) and configured to provide a reference voltage corresponding to a low limit for cell voltage defined in accordance with the SOA. In some examples, the voltage divider 408 converts a higher voltage (e.g., supply voltage Vin) into a lower one (e.g., reference voltage) and is implemented using two resistors R1, R2 in series, where the output of the voltage divider is taken at the junction of the resistors. For comparison, the voltage measurement for a battery cell 106 indicated by one of the one or more analog signals 208 is provided to the non-inverting input (+). When the voltage measurement for the battery cell is below the reference voltage, the comparator outputs a contactor control signal 126 that indicates the battery cell is operating below the cell voltage range defined by the SOA (e.g., the contactor control signal 126 is asserted high). Otherwise, the comparator outputs a contactor control signal 126 that indicates the battery cell is operating within the cell voltage range defined by the SOA (e.g., the contactor control signal 126 is asserted low).

In the example of FIG. 4, a second analog comparator 406 is a high limit comparator. For example, the second analog comparator 406 is configured to detect overvoltage in a battery cell. In such an example, a second voltage divider 410 is coupled to the non-inverting input (+) and configured to provide a reference voltage corresponding to a high limit for cell voltage defined in accordance with the SOA. In some examples, the voltage divider 410 is implemented using two resistors R3, R4 in series, where the output of the voltage divider is taken at the junction of the resistors. For comparison, the voltage measurement for a battery cell 106 indicated by one of the one or more analog signals 208 is provided to the inverting input (−). When the voltage measurement for the battery cell is above the reference voltage, the comparator outputs a contactor control signal 126 that indicates the battery cell is operating above the cell voltage range defined by the SOA (e.g., the contactor control signal 126 is asserted high). Otherwise, the comparator outputs a contactor control signal 126 that indicates the battery cell is operating within the cell voltage range defined by the SOA (e.g., the contactor control signal 126 is asserted low). Accordingly, together the analog comparators 404, 406 change the state of the contactor control signal 126 when the battery cell voltage is below (undervoltage) or above (overvoltage) respective voltage limits that define the SOA of the battery to place the battery in a safe state. In response to the change in state of the contactor control signal 126, the contactor 122 opens the circuit that supplies power to the load 124.

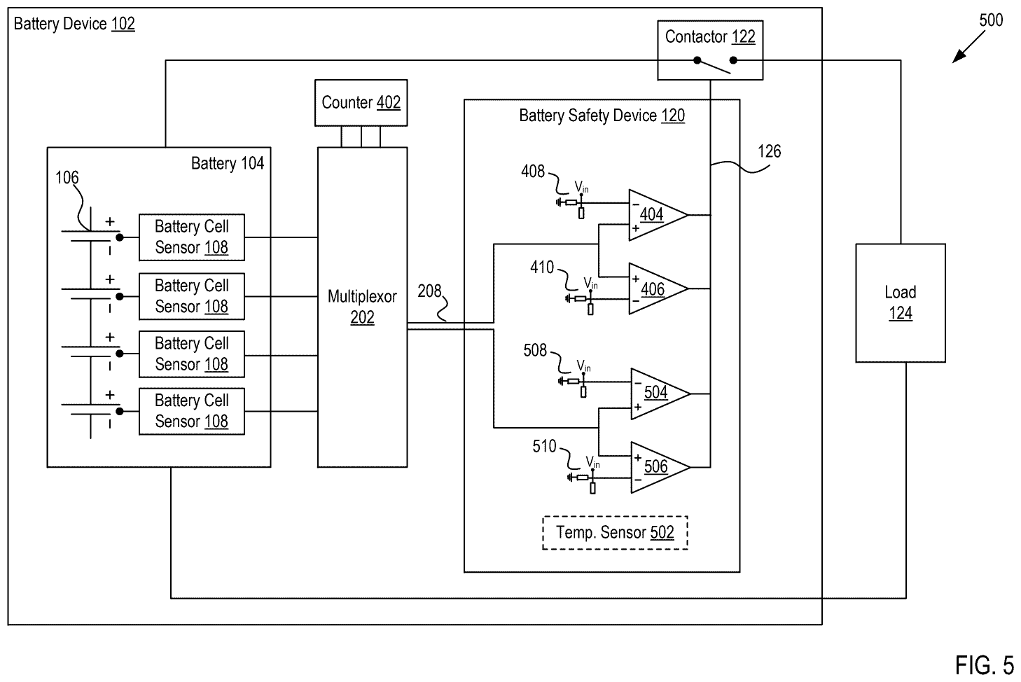

For further explanation, FIG. 5 sets forth a block diagram of an example system 500 including a battery safety device for ensuring compliance with functional safety requirements in accordance with at least one embodiment of the present disclosure, where the system 500 extends the example system 400 of FIG. 4, where like numerals indicate like elements. The example system of FIG. 5 includes analog comparators 504, 506 for detecting under-temperature and over-temperature. In the example of FIG. 5, a third analog comparator 404 is a low limit comparator configured to detect under-temperature of a battery cell. In such an example, a third voltage divider 508 is coupled to the inverting input (−) and configured to provide a reference voltage corresponding to a low limit for cell temperature defined in accordance with the SOA. In some examples, the voltage divider is implemented using two resistors in series, where the output of the voltage divider is taken at the junction of the resistors. For comparison, a voltage signal indicating a temperature measurement for a battery cell 106 is supplied by one of the one or more analog signals 208 and is provided to the non-inverting input (+). When the voltage signal indicating the temperature measurement for the battery cell is below the reference voltage, the comparator outputs a contactor control signal 126 that indicates the battery cell is operating below the temperature range defined by the SOA (e.g., the contactor control signal 126 is asserted high). Otherwise, the comparator outputs a contactor control signal 126 that indicates the battery cell is operating within the temperature range defined by the SOA (e.g., the contactor control signal 126 is asserted low).

In the example of FIG. 5, a fourth analog comparator 506 is a high limit comparator. configured to detect over-temperature in a battery cell. In such an example, a fourth voltage divider 510 is coupled to the non-inverting input (+) and configured to provide a reference voltage corresponding to a high limit for cell temperature defined in accordance with the SOA. In some examples, the voltage divider 510 is implemented using two resistors in series, where the output of the voltage divider is taken at the junction of the resistors. For comparison, the voltage signal indicating the temperature measurement for a battery cell 106 is provided to the inverting input (−). When the voltage signal indicating the temperature measurement is above the reference voltage, the comparator outputs a contactor control signal 126 that indicates the battery cell is operating above the cell temperature range defined by the SOA (e.g., the contactor control signal 126 is asserted high). Otherwise, the comparator outputs a contactor control signal 126 that indicates the battery cell is operating within the cell temperature range defined by the SOA (e.g., the contactor control signal 126 is asserted low). Accordingly, together the analog comparators 404, 406 change the state of the contactor control signal 126 when the battery cell voltage is below (under-temperature) or above (over-temperature) respective temperature limits that define the SOA of the battery to place the battery in a safe state. In response to the change in state of the contactor control signal 126, the contactor 122 opens the circuit that supplies power to the load 124.

In another variation of the example system 500 of FIG. 5, the voltage signal indicating a temperature measurement, supplied to the non-inverting input (+) of comparator 504 and to the inverting input (−) of comparator 506, is provided by an ambient temperature sensor 502 in the battery safety device 120, where the battery safety device 120 is placed in close proximity to the battery 104 (e.g., within a battery pack that includes the battery 104).

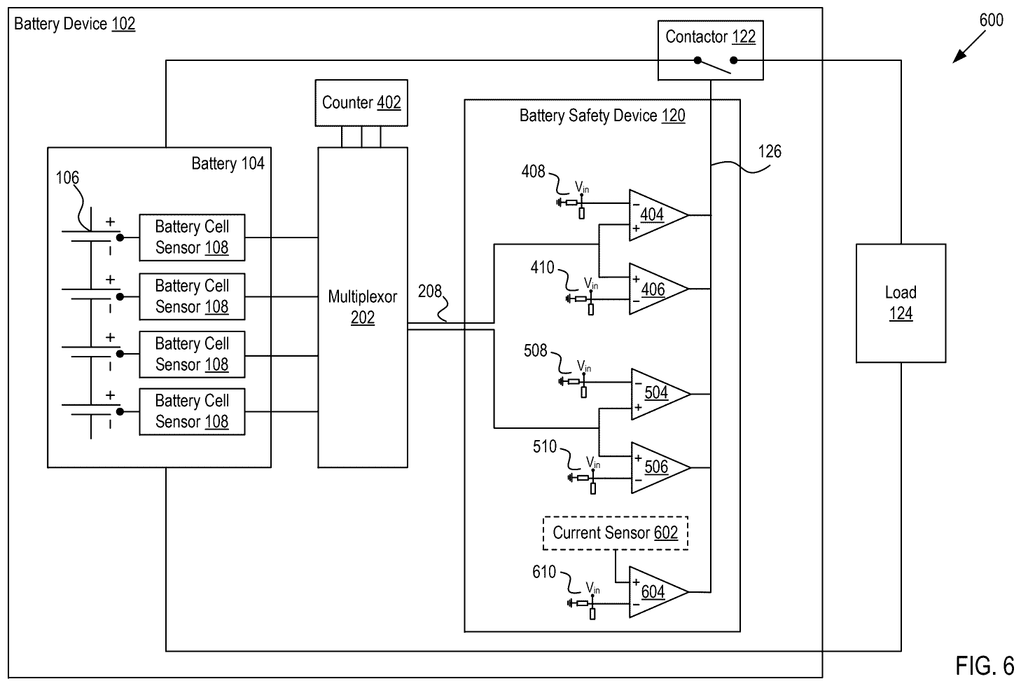

For further explanation, FIG. 6 sets forth a block diagram of an example system 600 including a battery safety device for ensuring compliance with functional safety requirements in accordance with at least one embodiment of the present disclosure, where the system 600 extends the example system 500 of FIG. 5, where like numerals indicate like elements. The example system of FIG. 6 includes a fifth analog comparator 604 for detecting over current. In such an example, a fifth voltage divider 610 is coupled to the non-inverting input (+) and configured to provide a reference voltage corresponding to a high limit for cell current defined in accordance with the SOA. In some examples, the voltage divider 510 is implemented using two resistors in series, where the output of the voltage divider is taken at the junction of the resistors. For comparison, the voltage signal indicating a current measurement for a battery cell 106 is provided to the inverting input (−). The current measurement may be received as one of the analog signals 208 or may be received, as shown, from a current sensor 602 of the battery safety device 120. For example, the current sensor outputs voltage signal proportional to a voltage drop across a shunt resistor coupled to the cell voltage signal. When the voltage signal indicating the current measurement is above the reference voltage, the comparator outputs a contactor control signal 126 that indicates the battery cell is operating above the cell current range defined by the SOA (e.g., the contactor control signal 126 is asserted high). Otherwise, the comparator outputs a contactor control signal 126 that indicates the battery cell is operating within the cell current range defined by the SOA (e.g., the contactor control signal 126 is asserted low).

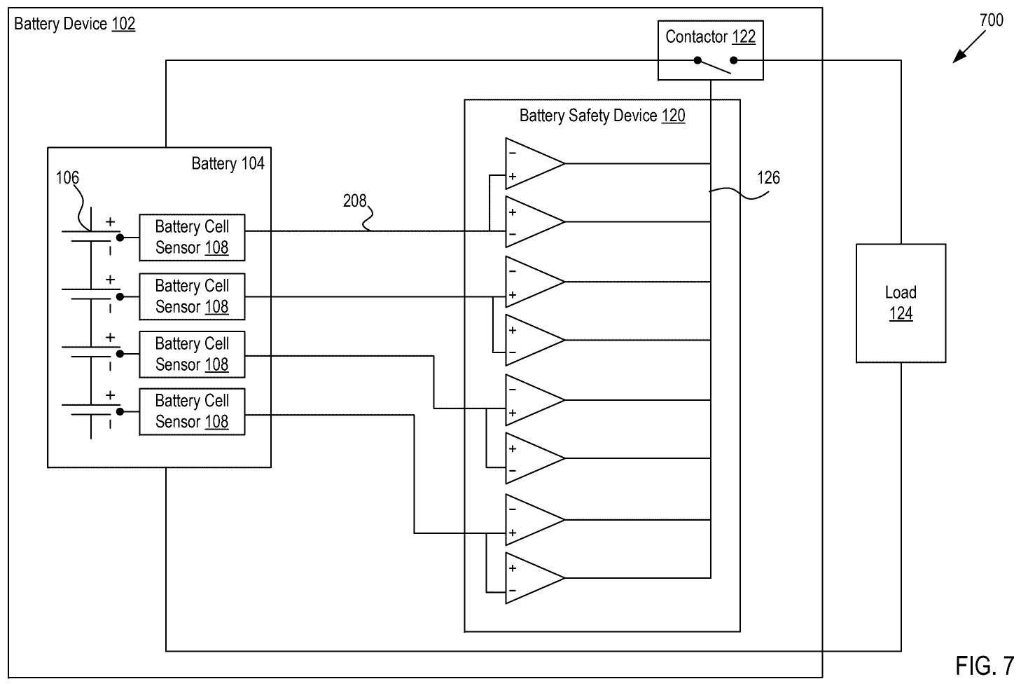

For further explanation, FIG. 7 sets forth a block diagram of an example system 700 including a battery safety device for ensuring compliance with functional safety requirements in accordance with at least one embodiment of the present disclosure, where the system 700 is one variation of the example system 400 of FIG. 4. In the example system 700 of FIG. 7, the one or more multiplexors 202 is replaced with analog comparators for each battery cell 106. In this way, the multiplexor addressing can be omitted, which may in some cases simplify the system design.

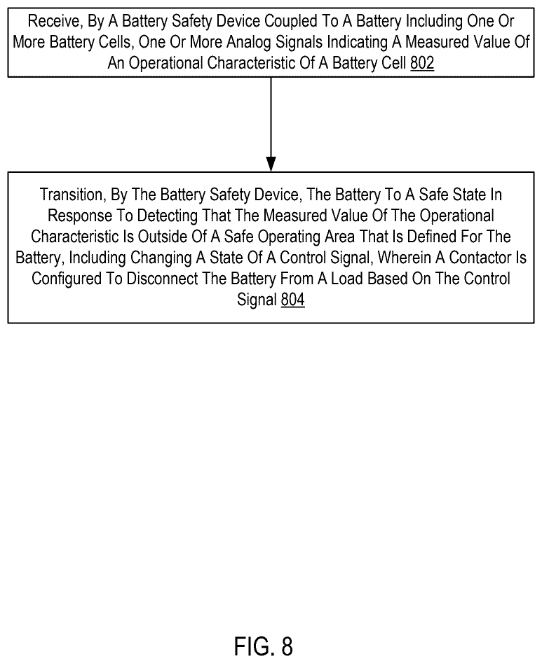

For further explanation, FIG. 8 sets forth a flow chart of an example method of a battery safety device for ensuring compliance with functional safety requirements in accordance with at least one embodiment of the present disclosure. The method of FIG. 8 includes receiving 802, by a battery safety device coupled to a battery including one or more battery cells, one or more analog signals indicating a measured value of an operational characteristic of a battery cell. For example, the battery safety device can be any of the battery safety devices described with reference to FIGS. 1-7.

The method also includes transitioning 804, by the battery safety device, the battery to a safe state in response to detecting that the measured value of the operational characteristic is outside of a safe operating area that is defined for the battery, including changing a state of a control signal, wherein a contactor is configured to disconnect the battery from a load based on the control signal. For example, transitioning 804 the battery to a safe state can be carried out by opening a contactor to disconnect the battery from a load.

Embodiments in accordance with the present disclosure separate functional safety functions from the BMS. Hence, compliance with functional safety standards can be achieved for existing battery management systems that are currently not compliant with any functional safety standard. Further, embodiments do not require safety certified battery monitoring devices such AFEs that are used as a part of a conventional BMS. As such, battery monitoring devices that are used by an associated BMS can be replaced with less expensive or less complex monitoring devices that are not safety certified. With the embodiments herein, functional safety standard compliance becomes an add-on to a BMS, allowing field upgrade with certified functional safety features and reducing the time to market for developing BMS's that do not include functional safety compliant features. The amount of effort and cost related to the development of functional safety standard compliant devices is reduced due to the separation of functional safety from the BMS and due to optimized simplicity. Further, reliability is increased over a traditional BMS due to the limited amount of components that implement the protection. Still further, the risk of systematic failures is inherently less than a conventional BMS, as no software is present and the hardware architecture is simplified.

In view of the foregoing, it will be appreciate that these advantages are accomplished by embodiments of the present disclosure. An embodiment is directed to an apparatus for battery safety device for ensuring compliance with functional safety requirements. The apparatus includes a battery having one or more battery cells. The apparatus also includes a battery safety device coupled to the battery, where the battery safety device is configured to receive one or more analog signals indicating a measured value of an operational characteristic of a battery cell. The battery safety device is also configured to change a state of a control signal in response to detecting that the measured value of the operational characteristic is outside of a safe operating area that is defined for the battery. The apparatus also includes a contactor configured to disconnect the battery from a load based on the control signal. The battery safety device is remote from a battery management system. In some examples, the operational characteristic includes at least one of voltage, temperature, and current. In some examples, the apparatus also includes a battery pack enclosing the battery and the battery safety device.

In some variations, the battery safety device comprises two or more analog comparators. The two or more analog comparators include a first analog comparator configured to change a state of a control signal in response to detecting that the measured value of an operational characteristic of the battery is below a low limit. The two or more analog comparators also include a second analog comparator configured to change a state of the control signal in response to detecting that the measured value of the operational characteristic of the battery is above a high limit.

In some examples, the first analog comparator receives a first reference voltage from a first voltage divider at an inverting input and a voltage signal indicating the measured value at a non-inverting input, wherein the first reference voltage represents the low limit. The second analog comparator receives a second reference voltage from a first voltage divider at a non-inverting input and the voltage signal indicating the measured value at an inverting input, wherein the second reference voltage represents the high limit. In some variations, there are two or more comparators for each battery cell, each comparator being configured to change the state of the control signal.

In some examples, the apparatus also includes a binary counter coupled to address inputs of a multiplexor, wherein the multiplexor selects one or more analog signals of a particular battery cell for output to the first analog comparator and the second analog comparator.

In some examples, the battery safety device includes one or more analog-to-digital converters configured to receive an analog signal indicating the measured value of the operational characteristic and convert the measured value to a digital signal. In these examples, the apparatus also includes a controller configured to receive the digital signal and change the state of the control signal in response to detecting that the measured value of the operational characteristic of the battery is either below a low limit or above a high limit for safe operating area.

In some examples, the apparatus includes a multiplexor that receives one or more analog signals from each of the one or more battery cells. The controller is coupled to the multiplexor via address lines and controller selects, via the address lines, one or more analog signals of a particular battery cell for output by the multiplexor to the battery safety device.

Another embodiment is direct to an electric vehicle. The electric vehicle includes an inverter coupled to an electric power distribution system. The electric vehicle also includes a battery coupled to the electric power distribution system. The battery includes one or more battery cells. The electric vehicle also includes a battery safety device coupled to the battery. The battery safety device is configured to receive one or more analog signals indicating a measured value of an operational characteristic of a battery cell. The battery safety device is also configured to change a state of a control signal in response to detecting that the measured value of the operational characteristic is outside of a safe operating area that is defined for the battery. The electric vehicle also includes a contactor configured to disconnect the battery from the electric power distribution system based on the control signal. The battery safety device is remote from a battery management system. In some examples, the operational characteristic includes at least one of voltage, temperature, and current. In some examples, the apparatus also includes a battery pack enclosing the battery and the battery safety device.

In some variations, the battery safety device comprises two or more analog comparators. The two or more analog comparators include a first analog comparator configured to change a state of a control signal in response to detecting that the measured value of an operational characteristic of the battery is below a low limit. The two or more analog comparators also include a second analog comparator configured to change a state of the control signal in response to detecting that the measured value of the operational characteristic of the battery is above a high limit.

In some examples, the first analog comparator receives a first reference voltage from a first voltage divider at an inverting input and a voltage signal indicating the measured value at a non-inverting input, wherein the first reference voltage represents the low limit. The second analog comparator receives a second reference voltage from a first voltage divider at a non-inverting input and the voltage signal indicating the measured value at an inverting input, wherein the second reference voltage represents the high limit. In some variations, there are two or more comparators for each battery cell, each comparator being configured to change the state of the control signal.

In some examples, the electric vehicle also includes a binary counter coupled to address inputs of a multiplexor, wherein the multiplexor selects one or more analog signals of a particular battery cell for output to the first analog comparator and the second analog comparator.

In some examples, the battery safety device includes one or more analog-to-digital converters configured to receive an analog signal indicating the measured value of the operational characteristic and convert the measured value to a digital signal. In these examples, the apparatus also includes a controller configured to receive the digital signal and change the state of the control signal in response to detecting that the measured value of the operational characteristic of the battery is either below a low limit or above a high limit for safe operating area.

In some examples, the electric vehicle includes a multiplexor that receives one or more analog signals from each of the one or more battery cells. The controller is coupled to the multiplexor via address lines and controller selects, via the address lines, one or more analog signals of a particular battery cell for output by the multiplexor to the battery safety device.

Another embodiment is directed to a method for a battery safety device for ensuring compliance with functional safety requirements. The method includes receiving, by a battery safety device coupled to a battery including one or more battery cells, one or more analog signals indicating a measured value of an operational characteristic of a battery cell. The method also includes transitioning, by the battery safety device, the battery to a safe state in response to detecting that the measured value of the operational characteristic is outside of a safe operating area that is defined for the battery, including changing a state of a control signal, wherein a contactor is configured to disconnect the battery from a load based on the control signal. The battery safety device is remote from a battery management system.

In some examples, the battery safety device comprises two or more analog comparators. The two or more analog comparators include a first analog comparator configured to change a state of a control signal in response to detecting that the measured value of an operational characteristic of the battery is below a low limit. The two or more analog comparators also include a second analog comparator configured to change a state of the control signal in response to detecting that the measured value of the operational characteristic of the battery is above a high limit.

In some examples, the battery safety device includes one or more analog-to-digital converters configured to receive an analog signal indicating the measured value of the operational characteristic and convert the measured value to a digital signal. In these examples, the apparatus also includes a controller configured to receive the digital signal and change the state of the control signal in response to detecting that the measured value of the operational characteristic of the battery is either below a low limit or above a high limit for safe operating area.

Exemplary embodiments of the present invention are described largely in the context of a fully functional system for a battery safety device for ensuring compliance with functional safety requirements. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, an apparatus, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or other devices to cause a series of operational steps to be performed on the computer, other programmable apparatuses or other devices to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, apparatuses, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. An apparatus comprising:
a battery comprising one or more battery cells;
a battery safety device coupled to the battery, the battery safety device configured to:
receive one or more analog signals indicating a measured value of an operational characteristic of a battery cell; and
change a state of a control signal in response to detecting that the measured value of the operational characteristic is outside of a safe operating area that is defined for the battery; and
a contactor configured to disconnect the battery from a load based on the control signal.

2. The apparatus of claim 1, wherein the operational characteristic includes at least one of voltage, temperature, and current.

3. The apparatus of claim 1 further comprising a battery pack enclosing the battery and the battery safety device.

4. The apparatus of claim 1, wherein the battery safety device is remote from a battery management system.

5. The apparatus of claim 1, wherein the battery safety device comprises two or more analog comparators including:
a first analog comparator configured to change a state of a control signal in response to detecting that the measured value of an operational characteristic of the battery is below a low limit; and
a second analog comparator configured to change a state of the control signal in response to detecting that the measured value of the operational characteristic of the battery is above a high limit.

6. The apparatus of claim 5, wherein the first analog comparator receives a first reference voltage from a first voltage divider at an inverting input and a voltage signal indicating the measured value at a non-inverting input, wherein the first reference voltage represents the low limit; and
wherein the second analog comparator receives a second reference voltage from a first voltage divider at a non-inverting input and the voltage signal indicating the measured value at an inverting input, wherein the second reference voltage represents the high limit.

7. The apparatus of claim 5, further comprising a binary counter coupled to address inputs of a multiplexor, wherein the multiplexor selects one or more analog signals of a particular battery cell for output to the first analog comparator and the second analog comparator.

8. The apparatus of claim 5, wherein there are two or more comparators for each battery cell, each comparator being configured to change the state of the control signal.

9. The apparatus of claim 1, wherein the battery safety device comprises:
one or more analog-to-digital converters configured to receive an analog signal indicating the measured value of the operational characteristic and convert the measured value to a digital signal; and
a controller configured to receive the digital signal and change the state of the control signal in response to detecting that the measured value of the operational characteristic of the battery is either below a low limit or above a high limit for safe operating area.

10. The apparatus of claim 9 further comprising a multiplexor that receives one or more analog signals from each of the one or more battery cells; wherein the controller is coupled to the multiplexor via address lines; and wherein the controller selects, via the address lines, one or more analog signals of a particular battery cell for output by the multiplexor to the battery safety device.

11. An electric vehicle comprising:
an inverter coupled to an electric power distribution system;
a battery coupled to the electric power distribution system, the battery comprising one or more battery cells;
a battery safety device coupled to the battery, the battery safety device configured to:
receive one or more analog signals indicating a measured value of an operational characteristic of a battery cell; and
change a state of a control signal in response to detecting that the measured value of the operational characteristic is outside of a safe operating area that is defined for the battery; and
a contactor configured to disconnect the battery from the electric power distribution system based on the control signal.

12. The electric vehicle of claim 11, wherein the operational characteristic includes at least one of voltage, temperature, and current.

13. The electric vehicle of claim 11, wherein the battery safety device is remote from a battery management system.

14. The electric vehicle of claim 11, wherein the battery safety device comprises two or more analog comparators, including:
a first analog comparator configured to change a state of a control signal in response to detecting that the measured value of an operational characteristic of the battery is below a low limit; and
a second analog comparator configured to change a state of the control signal in response to detecting that the measured value of the operational characteristic of the battery is above a high limit.

15. The electric vehicle of claim 14, wherein the first analog comparator receives a first reference voltage from a first voltage divider at an inverting input and a voltage signal indicating the measured value at a non-inverting input, wherein the first reference voltage represents the low limit; and
wherein the second analog comparator receives a second reference voltage from a first voltage divider at a non-inverting input and the voltage signal indicating the measured value at an inverting input, wherein the second reference voltage represents the high limit.

16. The electric vehicle of claim 11, wherein the battery safety device comprises:
one or more analog-to-digital converters configured to receive an analog signal indicating the measured value of the operational characteristic and convert the measured value to a digital signal; and
a controller configured to receive the digital signal and change the state of the control signal in response to detecting that the measured value of the operational characteristic of the battery is either below a low limit or above a high limit for safe operating area.

17. A method comprising:
receiving, by a battery safety device coupled to a battery including one or more battery cells, one or more analog signals indicating a measured value of an operational characteristic of a battery cell; and
transitioning, by the battery safety device, the battery to a safe state in response to detecting that the measured value of the operational characteristic is outside of a safe operating area that is defined for the battery, including changing a state of a control signal, wherein a contactor is configured to disconnect the battery from a load based on the control signal.

18. The method of claim 17, wherein the battery safety device comprises two or more analog comparators, including:
a first analog comparator configured to change a state of a control signal in response to detecting that the measured value of an operational characteristic of the battery is below a low limit; and
a second analog comparator configured to change a state of the control signal in response to detecting that the measured value of the operational characteristic of the battery is above a high limit.

19. The method of claim 17, wherein the battery safety device comprises:
one or more analog-to-digital converters configured to receive an analog signal indicating the measured value of the operational characteristic and convert the measured value to a digital signal; and
a controller configured to receive the digital signal and change the state of the control signal in response to detecting that the measured value of the operational characteristic of the battery is either below a low limit or above a high limit for safe operating area.

20. The method of claim 17, wherein the battery safety device is remote from a battery management system.
